(19) United States
(12) Patent Application Publication
(10) Pub. No.: US 2026/0277140 A1
(43) Pub. Date: Sep. 17, 2026

(54) FIXING DEVICE AND IMAGE FORMING APPARATUS

(71) Applicant: KYOCERA Document Solutions Inc., Osaka (JP)

(72) Inventor: Yasuhito OKAJIMA, Osaka (JP)

(73) Assignee: KYOCERA Document Solutions Inc., Osaka (JP)

(21) Appl. No.: 19/555,028

(22) Filed: Mar. 3, 2026

(30) Foreign Application Priority Data
Mar. 12, 2025 (JP) 2025-039625

(51) Int. Cl. G03G 15/20

(52) U.S. Cl. CPC G03G 15/2025; G03G 15/2064; G03G 2215/2025

(57) ABSTRACT

A fixing device includes a fixing belt, a nip forming member, a sliding member, and a pressing member. The nip forming member is disposed radially inward of the fixing belt and has an opposing face that faces the inner circumferential surface of the fixing belt at the fixing nip portion and a non-opposing face that does not face the inner circumferential surface. The sliding member is sheet-form and is disposed between the inner circumferential surface of the fixing belt and the opposing face of the nip forming member such that the inner circumferential surface of the rotating fixing belt makes contact with, while sliding across, the sliding member. The sliding member is formed integrally with the non-opposing face of the nip forming member.

### INCORPORATION BY REFERENCE

This application is based on and claims the benefit of priority from Japanese Patent Application No. 2025-039625 filed on Mar. 12, 2025, the contents of which are hereby incorporated by reference.

### BACKGROUND

The present disclosure relates to a fixing device and an image forming apparatus.

Many electrophotographic image forming apparatuses such as copiers and printers employ a fixing device that uses a heat fixing method to fix an unfixed toner image formed on a sheet-form recording medium to a recording medium. The recording medium passes through a fixing nip portion formed by a heating member and a pressing member in contact with each other, where it is heated and pressed to have the unfixed toner image fixed to it.

### SUMMARY

According to one aspect of the present disclosure, a fixing device includes a fixing belt, a nip forming member, a sliding member, a support member, and a pressing member. The fixing device inserts a recording medium into a fixing nip portion and heats and presses the recording medium, thereby fixing a toner image formed on the recording medium to the recording medium. The fixing belt is endless, is heated by a heating portion, and rotates in the recording medium conveying direction. The nip forming member is disposed radially inward of the fixing belt and has an opposing face that faces the inner circumferential surface of the fixing belt at the fixing nip portion and a non-opposing face that does not face the inner circumferential surface. The sliding member is sheet-form and is disposed between the inner circumferential surface of the fixing belt and the opposing face of the nip forming member such that the inner circumferential surface of the rotating fixing belt makes contact with, while sliding across, the sliding member. The support member is disposed radially inward of the fixing belt and supports the nip forming member. The pressing member makes contact with the nip forming member across the sliding member and the fixing belt with a predetermined pressure so as to form the fixing nip portion between the pressing member and the fixing belt. The sliding member is formed integrally with the non-opposing face of the nip forming member or with a resin member disposed adjacent to the non-opposing faces.

### BRIEF DESCRIPTION OF THE DRAWINGS

FIG. 1 is a schematic sectional front view of an image forming apparatus according to one embodiment of the present disclosure.

FIG. 2 is a sectional front view of a fixing device in the image forming apparatus in FIG. 1.

FIG. 3 is a cut-end side view of the fixing device in the image forming apparatus in FIG. 1.

FIG. 4 is an illustrative diagram showing the assembly of a sliding member in the fixing device in FIG. 2.

FIG. 5 is an enlarged sectional front view around a fixing nip portion of the fixing device in FIG. 2.

### DETAILED DESCRIPTION

An embodiment of the present disclosure will be described below with reference to the accompanying drawings. The embodiment described below is not meant to limit the scope of the present disclosure.

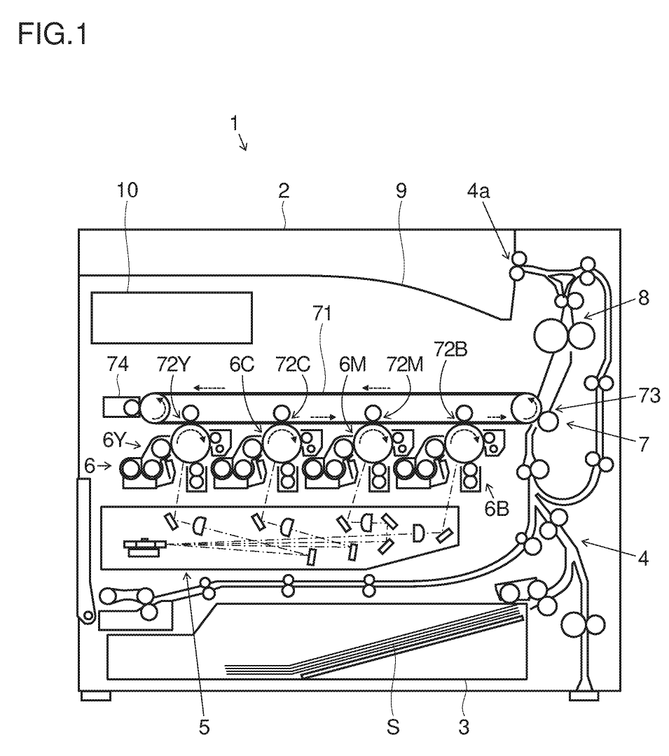

FIG. 1 is a schematic sectional front view of an image forming apparatus 1 of the embodiment. One example of the image forming apparatus 1 of the embodiment is a tandem-type color printer that transfers a toner image to a sheet (recording medium) S using an intermediate transfer belt 71. The image forming apparatus 1 may be what is called a multifunction peripheral that has the functions of printing, scanning (image reading), facsimile transmission, and the like.

As shown in FIG. 1, the image forming apparatus 1 includes a sheet feed portion 3, a sheet conveying portion 4, an exposure portion 5, an image forming portion 6, a transfer portion 7, a fixing device 8, a sheet discharge portion 9, and a control portion 10, which all are provided in an apparatus body 2.

The sheet feed portion 3 is disposed in a bottom part of the apparatus body 2. The sheet feed portion 3 stores a plurality of unprinted sheets (recording medium) S and separates and feeds them out one sheet S at a time during printing. The sheet conveying portion 4 extends vertically along a side wall of the apparatus body 2. The sheet conveying portion 4 conveys the sheet S fed out from the sheet feed portion 3 to a secondary transfer portion 73 and the fixing device 8 and then discharges the fixed sheet S through a sheet discharge port 4a to the sheet discharge portion 9.

The exposure portion 5 is disposed above the sheet feed portion 3. The exposure portion 5 shines laser light controlled based on image data to the image forming portion 6.

The image forming portion 6 is disposed above the exposure portion 5, below the intermediate transfer belt 71. The image forming portion 6 comprises a yellow image forming portion 6Y, a cyan image forming portion 6C, a magenta image forming portion 6M, and a black image forming portion 6B. These four image forming portions 6 share the same basic configuration. Accordingly, the suffixes “Y”, “C”, “M”, and “B” for the different colors may be omitted unless distinction is necessary in the following descriptions.

The image forming portion 6 includes a photosensitive drum supported so as to be rotatable in a predetermined direction (clockwise in FIG. 1). The image forming portion 6 further includes a charging portion, a developing portion, and a drum cleaning portion disposed around the photosensitive drum along its rotational direction. A primary transfer portion 72 is disposed between the developing portion and the drum cleaning portion.

The photosensitive drum has a photosensitive layer formed on its outer circumferential surface. The charging portion electrostatically charges the outer circumferential surface of the photosensitive drum to a predetermined surface potential. The exposure portion 5 exposes to light the outer circumferential surface of the photosensitive drum electrostatically charged by the charging portion to form an electrostatic latent image based on a document image on the outer circumferential surface of the photosensitive drum with reduced electric charge. The developing portion feeds toner to the electrostatic latent image on the outer circumferential surface of the photosensitive drum to develop it into a toner image. The four image forming portions 6 each form a toner image of a different color. After the toner image is primarily transferred to the outer circumferential surface of the intermediate transfer belt 71, the drum cleaning portion cleans the photosensitive drum by removing the toner and the like remaining on its outer circumferential surface. In this way, the image forming portion 6 forms the image (toner image) to be transferred to the sheet S later.

The transfer portion 7 includes the intermediate transfer belt 71, the primary transfer portions 72Y, 72C, 72M, and 72B, the secondary transfer portion 73, and a belt cleaning portion 74. The intermediate transfer belt 71 is disposed above the four image forming portions 6. The intermediate transfer belt 71 is an endless intermediate transfer member that is supported so as to be rotatable in a predetermined direction (counterclockwise in FIG. 1) and to which the toner images formed respectively in the four image forming portions 6 are primarily transferred so as to be sequentially superimposed on each other. The four image forming portions 6 are disposed in what is called a tandem configuration by being aligned in a row from upstream to downstream along the rotational direction of the intermediate transfer belt 71.

The primary transfer portions 72Y, 72C, 72M, and 72B are disposed above the image forming portions of the different colors 6Y, 6C, 6M, and 6B across the intermediate transfer belt 71. The secondary transfer portion 73 is disposed upstream of the fixing device 8 with respect to the sheet conveying direction in the sheet conveying portion 4, downstream of the four image forming portions 6Y, 6C, 6M, and 6B with respect to the rotational direction of the intermediate transfer belt 71. The belt cleaning portion 74 is disposed downstream of the secondary transfer portion 73 with respect to the rotational direction of the intermediate transfer belt 71.

The primary transfer portion 72 transfers the toner image formed on the outer circumferential surface of the photosensitive drum to the intermediate transfer belt 71. In other words, the toner image is primarily transferred to the outer circumferential surface of the intermediate transfer belt 71 by the primary transfer portions 72Y, 72C, 72M, and 72B of the different colors. As the intermediate transfer belt 71 rotates, the toner images from the four image forming portions 6 are transferred to the intermediate transfer belt 71 with predetermined timing so as to be sequentially superimposed on each other. As a result, a color toner image resulting from the toner images of the four colors of yellow, cyan, magenta, and black being superimposed on each other is formed on the outer circumferential surface of the intermediate transfer belt 71.

The color toner image on the outer circumferential surface of the intermediate transfer belt 71 is transferred to the sheet S synchronously conveyed by the sheet conveying portion 4, at a secondary transfer nip portion formed in the secondary transfer portion 73. The belt cleaning portion 74 cleans the outer circumferential surface of the intermediate transfer belt 71 by removing the toner and the like left on it after secondary transfer. In this way, the transfer portion 7 transfers (records) the toner image formed on the outer circumferential surface of the photosensitive drum to the sheet S.

The fixing device 8 is disposed above the secondary transfer portion 73. The fixing device 8 fixes the toner image to the sheet S by heating and pressing the sheet S having the toner image transferred to it.

The sheet discharge portion 9 is disposed above the transfer portion 7. The sheet S having the toner image fixed to it and having completed printing is conveyed to the sheet discharge portion 9. The sheet discharge portion 9 allows the printed sheet (print result) to be retrieved from above.

The control portion 10 includes a CPU, an image processing portion, a storage portion, and other electronic circuits and components (of which none is illustrated). Based on control program and data stored in the storage portion, the CPU controls the operation of different parts of the image forming apparatus 1 to perform processes related to the functions of the image forming apparatus 1. The sheet feed portion 3, the sheet conveying portion 4, the exposure portion 5, the image forming portion 6, the transfer portion 7, and the fixing device 8 individually receive commands from the control portion 10 and operate in coordination to perform printing on the sheet S. The storage portion is configured, for example, as a combination of a non-volatile storage device (not illustrated) such as a program ROM (read-only memory) and a data ROM, and a volatile storage device (not illustrated), such as a RAM (random-access memory).

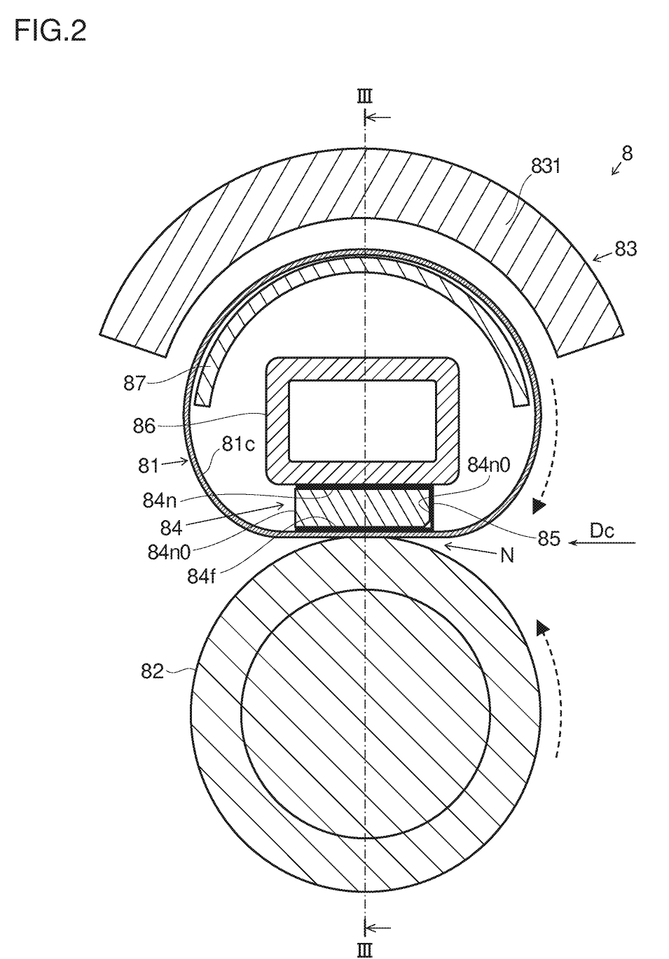

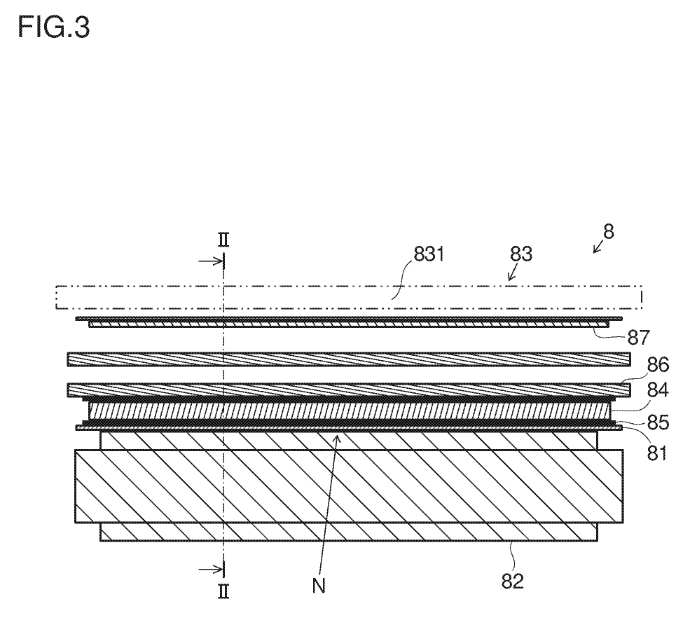

Next, a configuration of the fixing device 8 according to the embodiment will be described in detail. FIG. 2 is a sectional front view of the fixing device 8 in the image forming apparatus 1 in FIG. 1. FIG. 3 is a cut-end side view of the fixing device 8 in the image forming apparatus 1 in FIG. 1.

FIGS. 2 and 3, for convenience’ sake, shows a configuration in which the fixing belt 81 is disposed above a fixing nip portion N and a pressing roller (pressing member) 82 is disposed below it. The right side of FIG. 2 is the upstream side (closer to the transfer portion 7) and the left side is the downstream side (closer to the sheet discharge portion 9) with respect to the sheet conveying direction in the fixing device 8. FIG. 2 is a sectional view along line II-II in FIG. 3 and FIG. 3 is a cut-end view along line III-III in FIG. 2.

As shown in FIGS. 2 and 3, the fixing device 8 includes the fixing belt 81, the pressing roller (pressing member) 82, a heating portion 83, a nip forming member 84, a sliding member 85, a support member 86, and a belt guide 87.

The fixing belt 81 is supported on a housing portion of the fixing device 8 so as to be rotatable about a horizontal axis. The fixing belt 81 is endless and is configured, for example, in a cylindrical shape with an outer diameter of 20 [mm] to 50 [mm] that is longer than the pressing roller 82 in the rotational axis direction (i.e., the sheet width direction orthogonal to the sheet conveying direction, i.e., the direction into the plane of FIG. 2, i.e., the left-right direction in FIG. 3). The fixing belt 81 is rotatable along the conveying direction of the sheet S as a recording medium.

The fixing belt 81 has a stacked structure with an elastic layer and a release layer provided on the outer circumference of a heating layer as a base material layer. The heating layer is formed of, for example, a film of metal such as nickel with a thickness of 30 [μm] to 50 [μm], or a polyimide film with a thickness of 50 [μm] to 100 [μm] mixed with a powder of metal such as copper, silver, or aluminum. The elastic layer is formed of, for example, silicone rubber or the like with a thickness of 100 [μm] to 500 [μm]. The release layer is formed of, for example, fluorine resin such as PFA (tetrafluoroethylene perfluoroalkyl vinyl ether copolymer) with a thickness of 30 [μm] to 50 [μm]. The fixing belt 81 is heated by the heating portion 83.

The pressing roller 82 is supported on the housing portion of the fixing device 8 so as to be rotatable about a horizontal axis. The pressing roller 82 is configured in a cylindrical shape and is shorter than the fixing belt 81 along the rotational axis direction (i.e., the sheet width direction, i.e., the direction into the plane of FIG. 2, i.e., the left-right direction in FIG. 3).

The pressing roller 82 is pressed with a predetermined pressure toward the side of fixing belt 81 by a pressing mechanism (not illustrated). As a result, the pressing roller 82 makes contact with the outer circumferential surface of the fixing belt 81. In other words, the pressing roller 82 makes contact with the nip forming member 84 with the predetermined pressure across the sliding member 85 and the fixing belt 81. The fixing nip portion N is formed between the pressing roller 82 and the fixing belt 81.

The pressing roller 82 is coupled to a drive source (not illustrated) including, for example, a motor, and receives driving power from the motor to rotate counterclockwise in FIG. 2. The pressing roller 82 makes contact with the outer circumferential surface of the fixing belt 81 and gives a rotational driving force to the fixing belt 81. The fixing belt 81 rotates clockwise in FIG. 2 as the pressing roller 82 rotates. The operation of the fixing belt 81 is controlled by the control portion 10.

The pressing roller 82 has a stacked structure with an elastic layer and a release layer provided on the outer circumference of a metal core. The metal core is formed of, for example, metal such as iron or aluminum with a diameter of 20 [mm] to 25 [mm]. The elastic layer is formed of, for example, silicone rubber with a thickness of 3 [mm] to 8 [mm], and has an outer diameter of 30 [mm] to 35 [mm]. The release layer is formed of, for example, fluorine resin such as PFA with a thickness of approximately 10 [μm] to 50 [μm].

The heating portion 83 is disposed in a region at the side of the fixing belt 81 opposite from the side where the pressing roller 82 is disposed relative to the fixing belt 81, so as to face the outer circumferential surface of the fixing belt 81 across a predetermined gap. The heating portion 83 extends longer than the fixing belt 81 and the belt guide 87 along the rotational axis direction (sheet width direction) of the fixing belt 81.

The heating portion 83 includes an excitation coil 831, and also includes (though not illustrated) a holding member, a core, and the like. The excitation coil 831 and the core are held at predetermined positions relative to the fixing belt 81 by the holding member. The excitation coil 831 is formed of a Litz wire formed by bundling a plurality of conductors together and is wound so as to extend along the rotational axis direction (sheet width direction) of the fixing belt 81. The excitation coil 831 is formed in an arc shape along the outer circumferential surface of the fixing belt 81 along the circumferential direction of the fixing belt 81.

The heating portion 83 heats the fixing belt 81 by electromagnetic induction. More specifically, the heating portion 83 heats the heating layer of the fixing belt 81 by induction heating to heat the fixing belt 81. The heating portion 83 may instead be configured as a heater that is disposed close to the inner circumferential surface of the fixing belt 81 at the fixing nip portion N and that extends over the entire region of the fixing belt 81 along its rotational axis direction.

The nip forming member 84 is disposed radially inward of the fixing belt 81, across the sliding member 85 from the inner circumferential surface of the fixing belt 81. The nip forming member 84 is disposed to face the pressing roller 82 across the sliding member 85 and the fixing belt 81. The nip forming member 84 makes contact with the inner circumferential surface of the fixing belt 81 via the sliding member 85 to form the fixing nip portion N between the fixing belt 81 and the pressing roller 82.

The nip forming member 84 is in the shape of a rectangular parallelopiped that extends over nearly the same length as the fixing belt 81 along the rotational axis direction (sheet width direction) of the fixing belt 81. The nip forming member 84 has a base member formed of metal such as aluminum or heat resistant resin such as a liquid crystal polymer. The nip forming member 84 may also have an elastic layer formed of, for example, elastomer or silicone rubber, at its side facing the fixing belt 81 of the base member.

The sliding member 85 is disposed radially inward of the fixing belt 81 to be adjacent to it at the fixing nip portion N. The sliding member 85 is disposed between the inner circumferential surface of the fixing belt 81 and the nip forming member 84. With the sliding member 85, the inner circumferential surface of the rotating fixing belt 81 makes contact while sliding across it. The sliding member 85 is a sheet-form member with a thickness of approximately 0.5[mm]. The sliding member 85 is intended to reduce the sliding load between the inner circumferential surface of the fixing belt 81 and the nip forming member 84.

The support member 86 is disposed radially inward of the fixing belt 81. The support member 86 extends longer than the fixing belt 81 along the rotational axis direction (sheet width direction) of the fixing belt 81. The support member 86 is held by side plates (not illustrated) provided outward of the fixing belt 81 at opposite sides along the rotational axis direction to secure a sufficient pressing force between the support member 86 and the pressing roller 82. The support member 86 is formed, for example, as a member in the shape of a square column and supports the nip forming member 84 between itself and the inner surface of the fixing belt 81.

The belt guide 87 is disposed radially inward of the fixing belt 81 to face the heating portion 83 across the fixing belt 81. The belt guide 87 makes contact with the inner circumferential surface of the fixing belt 81 except at the fixing nip portion N to support the fixing belt 81 from radially inward. The belt guide 87 is formed of a metal plate that extends over nearly the same length as the fixing belt 81 along the rotational axis direction (sheet width direction) of the fixing belt 81.

The belt guide 87 is formed of an elastic magnetic metal, such as SUS430, with a thickness of 0.1 mm to 0.5 mm. The belt guide 87 serves to stabilize the rotation path of the fixing belt 81 and to enhance the heating efficiency of the fixing belt 81 by heating through absorption of the magnetic field that has permeated the fixing belt 81.

With the configuration described above, the fixing device 8 feeds the sheet S into the fixing nip portion N between the fixing belt 81 and the pressing roller 82, and heats and presses the sheet S to fix the toner image formed on the sheet S to the sheet S.

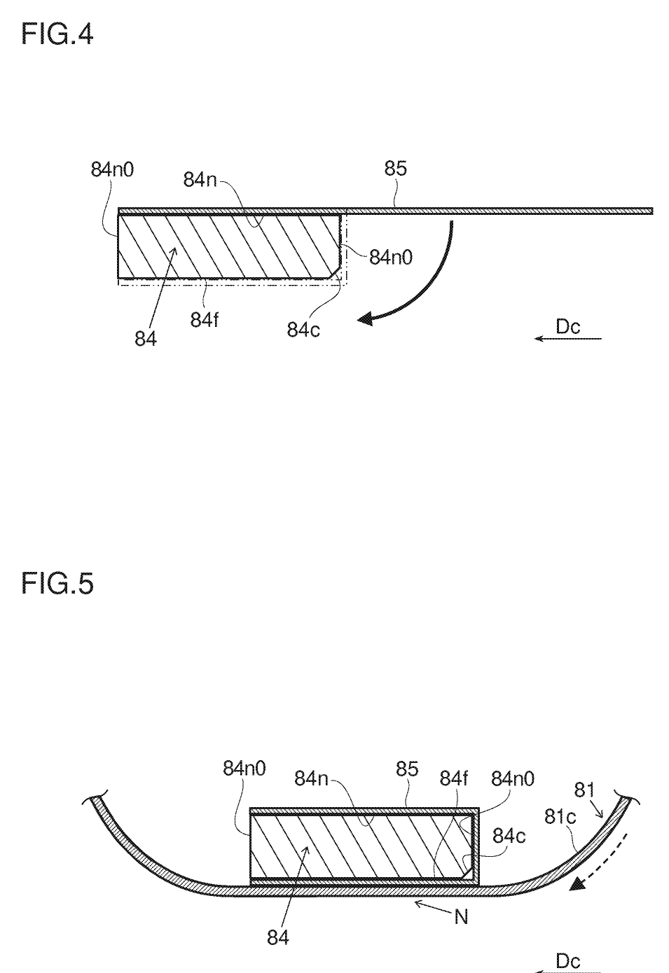

Next, the configuration of the nip forming member 84 and the sliding member 85 will be described in detail. FIG. 4 is an illustrative diagram showing the assembly of the sliding member 85 in the fixing device 8 in FIG. 2. FIG. 5 is an enlarged sectional front view around the fixing nip portion N of the fixing device 8 in FIG. 2. FIGS. 4 and 5 show the components necessary to illustrate the features of the nip forming member 84 and the sliding member 85, and the other components are omitted from illustration.

In FIGS. 4 and 5, the direction indicated by arrow Dc is the rotational direction of the fixing belt 81 (i.e., sheet conveying direction) and the direction into the plane of the figures is the rotational axis direction of the fixing belt 81 (i.e., sheet width direction). The rotational direction of the fixing belt 81 (sheet conveying direction) Dc and the rotational axis direction of the fixing belt 81 (sheet width direction) are orthogonal to each other.

As described above, the nip forming member 84 is in the shape of a rectangular parallelopiped that extends over nearly the same length as the fixing belt 81 along the rotational axis direction of the fixing belt 81 (sheet width direction). The nip forming member 84 has, on an outer circumferential part of it, an opposing face 84f that faces the fixing belt 81 and non-opposing faces 84n and 84n0.

The opposing face 84f is disposed at the side of the nip forming member 84 closer to the fixing nip portion N and faces an inner circumferential surface 81c of the fixing belt 81. In the embodiment, the opposing face 84f is, of those four outer circumferential faces of the nip forming member 84 in the shape of a rectangular parallelopiped which face the inner circumferential surface 81c of the fixing belt 81, the one face that faces the inner circumferential surface 81c of the fixing belt 81 at the fixing nip portion N and that extends both along the sheet conveying direction Dc and the sheet width direction.

The non-opposing faces 84n and 84n0 are faces that do not face the inner circumferential surface 81c of the fixing belt 81 at the fixing nip portion N. In the embodiment, the non-opposing faces 84n and 84n0 are, of those four outer circumferential faces of the nip forming member 84 in the shape of a rectangular parallelopiped which face the inner circumferential surface 81c of the fixing belt 81, the three faces, excluding the opposing face 84f, that extend along the sheet width direction.

The sliding member 85 is a sheet form member in the shape of a rectangular as seen in a plan view. As shown in FIGS. 4 and 5, the sliding member 85 is disposed to face the nip forming member 84 such that one end part (a left end part in FIG. 4) of the sliding member 85 along the direction (the left-right direction in FIG. 4) orthogonal to the sheet width direction (the direction into the plane of FIG. 4) lies along the non-opposing surface 84n of the nip forming member 84. The sliding member 85 is formed integrally with the non-opposing face 84n of the nip forming member 84. In the embodiment, the sliding member 85 is formed integrally with the non-opposing face 84n of the nip forming member 84 disposed opposite from the opposing face 84f to face the heating portion 83.

The sliding member 85 is formed integrally with the nip forming member 84 when the nip forming member 84, which is a resin member, is formed using a mold, by injecting resin into the mold with part of the sliding member 85 fixed in the mold. As a result, the sliding member 85 is formed integrally with the non-opposing face 84n of the nip forming member 84.

Another end part of the sliding member 85 (a right end part in FIG. 4) along the direction orthogonal to the sheet width direction (the left-right direction in FIG. 4) extends upstream of the fixing nip portion N along the rotational direction of the fixing belt 81. As shown in FIGS. 4 and 5, at the fixing nip portion N, the sliding member 85 is inserted between the nip forming member 84 and the fixing belt 81 from upstream along the rotational direction of the fixing belt 81. With this configuration, at the fixing nip portion N, the sliding member 85 is pulled downstream along the rotational direction of the fixing belt 81. This makes it possible to prevent the sliding member 85 from deviating from the fixing nip portion N as the fixing belt 81 rotates.

The above-mentioned other end part of the sliding member 85 (the right end part in FIG. 4) inserted between the nip forming member 84 and the fixing belt 81 at the fixing nip portion N is not fixed to any other member such as the nip forming member 84 and is a free end. With this configuration, if, at the fixing nip portion N, the sliding member 85 is pulled downstream along the rotational direction of the fixing belt 81, it is possible to suppress the load on the region of the sliding member 85 formed integrally with the non-opposing face 84n of the nip forming member 84. This helps prevent damage to the sliding member 85.

The sliding member 85 may be formed integrally with any other resin member disposed adjacent to the non-opposing faces 84n and 84n0 of the nip forming member 84.

The sliding member 85 is not limited to one formed integrally only with one non-opposing face 84n of the nip forming member 84. The sliding member 85 may be formed integrally with a plurality of faces of the nip forming member 84 including the non-opposing face 84n and any other non-opposing faces 84n0. The sliding member 85 may also be formed integrally with a plurality of faces including not only the non-opposing faces 84n and 84n0 of the nip forming member 84 but also any other resin member.

With the above configuration, the sliding member 85 is formed integrally with the non-opposing faces 84n and 84n0 of the nip forming member 84 located away from a sliding face with the fixing belt 81, or with a resin member. That is, the fixed region in which the sliding member 85 is fixed to the nip forming member 84 or a resin member is located away from the sliding face of the sliding member 85 with the fixing belt 81 and is less affected by sliding with the fixing belt 81 and is less likely to deform. Furthermore, the sliding member 85 is formed integrally with the nip forming member 84 or a resin member, and this prevents it from deforming as the fixing belt 81 rotates. In this way, it is possible to prevent troubles such as damage to the sliding member 85 and rotation failure of the fixing belt 81.

As shown in FIGS. 4 and 5, the nip forming member 84 has a chamfered portion 84c. The chamfered portion 84c is adjacent to the fixing nip portion N. Specifically, the chamfered portion 84c is formed at an upstream corner of the fixing nip portion N along the rotational direction of the fixing belt 81. The chamfered portion 84c extends along the rotational axis direction of the fixing belt 81 (the sheet width direction (i.e., the direction into the plane of FIGS. 4 and 5)).

With the above configuration, if, at the fixing nip portion N, the sliding member 85 is pulled downstream along the rotational direction of the fixing belt 81, it is possible to suppress concentration of a load on the corner of the sliding member 85 where the chamfered portion 84c is provided. This helps prevent damage to the sliding member 85.

As shown in FIGS. 4 and 5, the chamfered portion 84c of the nip forming member 84 may be in the form of a flat surface extending along the rotational axis direction of the fixing belt 81, or may instead be in the form of a curved surface (curved-surface portion).

Furthermore, the sliding member 85 is configured as a fibrous member. More specifically, the sliding member 85 is formed of, for example, a heat resistant fiber, like a fluorine resin such as PTFE (polytetrafluoroethylene). The fibrous member is effective in reducing the sliding load between the inner circumferential surface of the fixing belt 81 and the nip forming member 84; however, it may tend to deform easily as the fixing belt 81 rotates.

To cope with that, with the above configuration, even if the sliding member 85 is configured as a fibrous member that easily deforms, it is possible to suppress the load on the region of the sliding member 85 formed integrally with the non-opposing face 84n of the nip forming member 84. This helps prevent damage to the sliding member 85.

Furthermore, the sliding member 85 configured as a fiber member holds lubricant. Specifically, the sliding member 85 holds the lubricant in a form adsorbed and impregnated between fibers. This configuration makes it possible to more effectively reduce the sliding load between the inner circumferential surface of the fixing belt 81 and the nip forming member 84.

If, as in a conventional configuration, the fixed region in which the nip forming member 84 is fixed to the sliding member 85 is adjacent to the fixing nip portion N, the amount of lubricant that can be impregnated between fibers of the sliding member 85 may be small. In contrast, since the sliding member 85 of the embodiment is formed integrally with the non-opposing face 84n of the nip forming member 84 and the end part of the sliding member 85 closer to the fixing nip portion N is a free end, a large amount of lubricant can easily penetrate to reach the fixing nip portion N. This more effectively suppresses the load on the region of the sliding member 85 formed integrally with the non-opposing face 84n of the nip forming member 84.

While one embodiment of the present disclosure has been described above, it is not meant to limit the scope of the present disclosure, which thus allows for any modifications without departure from the spirit of what is disclosed herein.

For example, while the embodiment described above deals with an example where the image forming apparatus 1 is what is called a tandem-type image forming apparatus for color printing that forms images of a plurality of colors so as to superimpose them on each other, this is not meant as any limitation to such models. The image forming apparatus may be a non-tandem-type image forming apparatus for color printing or an image forming apparatus for monochrome printing.

What is claimed is:

1. A fixing device comprising:
an endless fixing belt that is heated by a heating portion and that rotates in a recording medium conveying direction;
a nip forming member disposed radially inward of the fixing belt, the nip forming member having an opposing face that faces an inner circumferential surface of the fixing belt at a fixing nip portion and a non-opposing face that does not face the inner circumferential surface;
a sheet-form sliding member disposed between the inner circumferential surface of the fixing belt and the opposing face of the nip forming member such that the inner circumferential surface of the rotating fixing belt makes contact with, while sliding across, the sliding member;
a support member disposed radially inward of the fixing belt, the support member supporting the nip forming member; and
a pressing member that makes contact with the nip forming member across the sliding member and the fixing belt with a predetermined pressure so as to form the fixing nip portion between the pressing member and the fixing belt; and
the fixing device inserting a recording medium into the fixing nip portion and heating and pressing the recording medium, thereby fixing a toner image formed on the recording medium to the recording medium,
wherein
the sliding member is formed integrally with the non-opposing face of the nip forming member.

2. The fixing device according to claim 1, wherein
at the fixing nip portion, the sliding member is inserted between the nip forming member and the fixing belt from upstream along a rotational direction of the fixing belt.

3. The fixing device according to claim 1, wherein
at an upstream corner of the fixing nip portion along the rotational direction of the fixing belt, the nip forming member has a chamfered portion or a curved-surface portion that extends along a rotational axis direction of the fixing belt.

4. The fixing device according to claim 1, wherein
the sliding member is configured as a fiber member.

5. The fixing device according to claim 4, wherein
the sliding member holds lubricant.

6. An image forming apparatus comprising:
an image forming portion that forms a toner image on the recording medium; and
the fixing device according to claim 1 that heats and presses the recording medium having the toner image formed thereon by the image forming portion to fix the toner image to the recording medium.
